(19) United States
(12) Patent Application Publication
(10) Pub. No.: US 2014/0337589 A1
(43) Pub. Date: Nov. 13, 2014

(54) PREVENTING A HYBRID MEMORY MODULE FROM BEING MAPPED

(71) Applicants: David G. Carpenter, Cypress, TX (US); William C. Hallowell, Spring, TX (US); Craig M. Belusar, Tomball, TX (US); Jason W. Kinsey, Tomball, TX (US); Raghavan V. Venugopal, Spring, TX (US); Reza M. Bacchus, Spring, TX (US)

(72) Inventors: David G. Carpenter, Cypress, TX (US); William C. Hallowell, Spring, TX (US); Craig M. Belusar, Tomball, TX (US); Jason W. Kinsey, Tomball, TX (US); Raghavan V. Venugopal, Spring, TX (US); Reza M. Bacchus, Spring, TX (US)

(21) Appl. No.: 14/368,769

(22) PCT Filed: Apr. 30, 2012
(86) PCT No.: PCT/US2012/035912

§ 371 Date: Jun. 25, 2014

(51) Int. Cl. G06F 3/06

(52) U.S. Cl. CPC G06F 3/0604; G06F 3/065; G06F 3/0685; G06F 3/0632; G06F 2003/0697
USPC 711/157; 711/154; 711/162

(57) ABSTRACT

A system includes a hybrid memory module. The hybrid memory module includes volatile memory and non-volatile memory. The system further includes a processor coupled to the hybrid memory module. The processor prevents the hybrid memory module from being mapped during a memory initialization routine by misrepresenting a status of the hybrid memory module.

### BACKGROUND

Any device that stores instructions or data needs memory, and there are two broad types of memory: volatile memory and nonvolatile memory. Volatile memory loses its stored data when it loses power or power is not refreshed periodically. Non-volatile memory, however, retains information without a continuous or periodic power supply.

Random access memory (“RAM”) is one type of volatile memory. As long as the addresses of the desired cells of RAM are known, RAM may be accessed in any order. Dynamic random access memory (“DRAM”) is one type of RAM. A capacitor is used to store a memory bit in DRAM, and the capacitor may be periodically refreshed to maintain a high electron state. Because the DRAM circuit is small and inexpensive, it may be used as memory for computer systems.

Flash memory is one type of non-volatile memory, and flash memory may be accessed in blocks or pages. For example, a page of flash memory may be erased in one operation or one “flash.” Accesses to flash memory are relatively slow compared with accesses to DRAM. As such, flash memory may be used as long term or persistent storage for computer systems.

### BRIEF DESCRIPTION OF THE DRAWINGS

For a detailed description of various examples, reference will now be made to the accompanying drawings in which:

FIG. 1 illustrates a system of preventing a hybrid memory module from being mapped in accordance with at least some examples;

FIG. 2 illustrates a method of preventing a hybrid memory module from being mapped in accordance with at least some examples; and

FIG. 3 illustrates a method of preventing a hybrid memory module from being mapped in accordance with at least some examples.

### DETAILED DESCRIPTION

Unexpected power failures can cause loss of important data that is stored in volatile memory but not stored in non-volatile memory. As such, a hybrid storage device containing volatile memory and non-volatile memory, with the non-volatile memory acting as a backup of the volatile memory, will mitigate losses due to unexpected power failures. However, when power returns, care should be taken not to let the non-volatile memory be initialized along with the volatile memory if the storage device is one that is normally subject to initialization procedures such as a dual in-line memory module (“DIMM”). Otherwise, initialization procedures will overwrite the data on the non-volatile memory before the data can be recovered from the non-volatile memory. One way to prevent such overwriting of data is to prevent the non-volatile memory from being mapped into a memory map used to initialize memory. If the non-volatile memory is not mapped, then it will be excluded from initialization procedures and its data will not be overwritten. As such, the data can be recovered following a power failure.

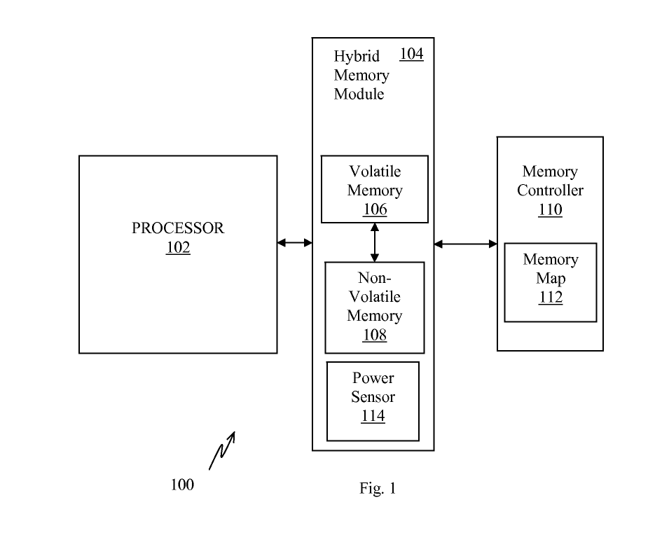

FIG. 1 illustrates a system 100 comprising a hybrid memory module 104 that includes volatile memory 106 and non-volatile memory 108. The system 100 of FIG. 1 prevents the hybrid memory module 104 from being mapped in accordance with at least some examples. The system 100 also may comprise a processor 102, which may be referred to as a central processing unit (“CPU”). The processor 102 may be implemented as one or more CPU chips, and may execute instructions, code, and computer programs.

The processor 102 may be coupled to the hybrid memory module 104, and the hybrid memory module 104 may comprise dynamic random access memory (“DRAM”) and flash memory. DRAM may be volatile memory 106 because each bit of data may be stored within a capacitor that is powered periodically to retain the bits. Flash memory, which stores bits using one or more transistors, may be non-volatile memory 108. In various examples, other types of volatile memory and non-volatile memory are used.

The hybrid memory module 104 may be coupled to a memory controller 110, which may comprise circuit logic to manage data flow by scheduling reading and writing to memory. The memory controller 110 may comprise a memory map 112 used to map one set of memory addresses to another set of memory addresses and keep track of locations of stale and fresh data. The memory map 112 may comprise a data structure such as an array, linked list, table, or database. In at least one example, the memory controller 110 may be integrated with the processor 102.

The hybrid memory module 104 may comprise a DIMM in at least one example. As such, both volatile and non-volatile memory may be provided on the same DIMM and be controlled by the same memory controller 110. In at least one example, half of the total DIMM memory may be implemented as volatile memory 106 and half may be implemented as non-volatile memory 108. In various other examples, the ratio of volatile memory 106 to non-volatile memory 108 may be other than equal amounts. The hybrid DIMM may fit in the DIMM slot of electronic devices without assistance from adaptive hardware.

The non-volatile memory 108 may act as a backup of volatile memory 106 in at least one example. As such, any content stored in volatile memory 106 may also be stored in non-volatile memory 108. The volatile memory 106 may be backed up by the memory controller 110 or processor 102 to the non-volatile memory 108 continuously or periodically according to situational needs. For example, the memory controller 110 or processor 102 may monitor address signals and command signals destined for the volatile memory 106. A successful write to the volatile memory 106 may trigger a backup of the written data to be stored in non-volatile memory 108. As a periodic example, the entire volatile memory 106 may be backed up to non-volatile memory 108 every thirty minutes.

The hybrid memory module 104 may also comprise a power sensor 114 in at least one example. The power sensor 114 may comprise logic that detects an imminent or occurring power failure and consequently triggers a backup of volatile memory 106 to non-volatile memory 108 or a check to ensure that non-volatile memory 108 is already backing up or has already backed up volatile memory 106. For example, the power sensor may be coupled to a power supply or charging capacitor coupled to the hybrid memory module 104. If the supplied power falls below a threshold, the backup may be triggered.

Any non-volatile memory 108 that is not utilized for backup purposes may be utilized for specific or general needs other than backing up volatile memory 106. Because such non-volatile memory 108 may be prevented from being mapped, extra non-volatile memory 108 not being used for backup may be efficiently utilized for sensitive data not necessarily stored in volatile memory 106.

During power failure or imminent power failure, contents of volatile memory 106 are copied to non-volatile memory 108. In at least one example, contents of volatile memory have been previously copied to non-volatile memory 108 as part of a continuous backup process. Upon power return, the processor 102 may perform a check to determine if the current power return was immediately preceded by a power failure. For example, the processor 102 may consider an event log that recorded a shutdown sequence initiated by a user as evidence that no power failure occurred. As another example, the processor 102 may consider the presence of set flags or existing data that should be cleared or deleted respectively during the shutdown sequence as evidence that a power failure occurred.

In order to use memory efficiently, the memory controller 110 may perform a memory interleaving algorithm. That is, the memory controller 110 may assign available non-contiguous memory, such as different memory modules or different memory dies on the same module, to store contiguous data across the non-contiguous memory. As such, the contiguous data may be read or written in parallel, which takes less time than reading or writing the data serially. The assignment of available memory may occur in a memory map 112. Specifically, the memory map 112 may map a set of contiguous of logical addresses to a set of non-contiguous physical addresses, which are selected from the available memory. For example, the mapping may be implemented as a table of entries including one column of logical addresses and another column of physical addresses, wherein a logical address is mapped to a physical address sharing the same row as the logical address.

Upon power return following a power failure, the hybrid memory module 104 may not be included as available memory in the memory interleaving algorithm. Specifically, the memory controller 110 or processor 102 may prevent the hybrid memory module 104 from being mapped in the memory map 112. One way the processor 102 can prevent such mapping is by misrepresenting the status of the hybrid memory module 104 as unavailable to the memory controller 110. For example, the processor 102 may send a set of physical addresses to the memory controller 110 with a status of available, the set excluding any physical addresses corresponding to the hybrid memory module 104 or non-volatile memory 108. The memory controller 110 may be restricted to choosing only the received physical addresses for mapping. As another example, the processor 102 may send a set of physical addresses to the memory controller 110 with a status of unavailable, the set including physical addresses corresponding to the hybrid memory module 104 or non-volatile memory 108. Alternatively, a starting and ending address may be sent to exclude the range of addresses between the starting and ending address.

Also, the hybrid memory module 104 may be represented as defective though the hybrid memory module 104 is not defective. For example, the processor 102 may send a set of physical addresses to the memory controller 110 with a status of defective, the set including physical addresses corresponding to the hybrid memory module 104 or non-volatile memory 108. Alternatively, the starting and ending address may be sent to exclude the range of addresses between the starting and ending address. In another example, the processor 102 may send a slot number to memory controller 110 with a status of defective, the slot number corresponding to the slot occupied by the hybrid memory module 104. Conversely, only the identity and status of non-defective slots may be sent. The memory controller 110 may exclude all addresses or slots received with a status of defective from being mapped in memory map 112, or the memory controller 110 may include all addresses or slots received with a non-defective status in memory map 112.

In another example, the hybrid memory module 104 may be represented as not installed though the hybrid memory module 104 is installed. For example, the processor 102 may send a set of physical addresses to the memory controller 110 with a status of uninstalled, the set including physical addresses corresponding to the hybrid memory module 104 or non-volatile memory 108. Alternatively, the starting and ending address may be sent to exclude the range of addresses between the starting and ending address. In another example, the processor 102 may send a slot number to memory controller 110 with a status of uninstalled, the slot number corresponding to the slot in which the hybrid memory module 104 is installed. Conversely, only the identity and status of slots with memory installed may be sent. The memory controller 110 may exclude all addresses or slots received with a status of uninstalled from being mapped in memory map 112, or the memory controller 110 may include all address or slots received with an installed status in memory map 112.

These misrepresentative statuses may be reported to the memory controller 110 before mapping or may be overwritten in the memory controller 110 before mapping. If the hybrid memory module 104 is already mapped, the processor 102 or memory controller 110 may adjust the entries referring to hybrid memory module 104 to a null value or delete the entries entirely before initialization procedures overwrite the non-volatile memory 108.

Upon power return, contents of the non-volatile memory 108 may be recovered. For example, the contents of the non-volatile memory may be copied to the volatile memory 106 to return the volatile memory 106 to a state identical to the state of the volatile memory 106 before power failure.

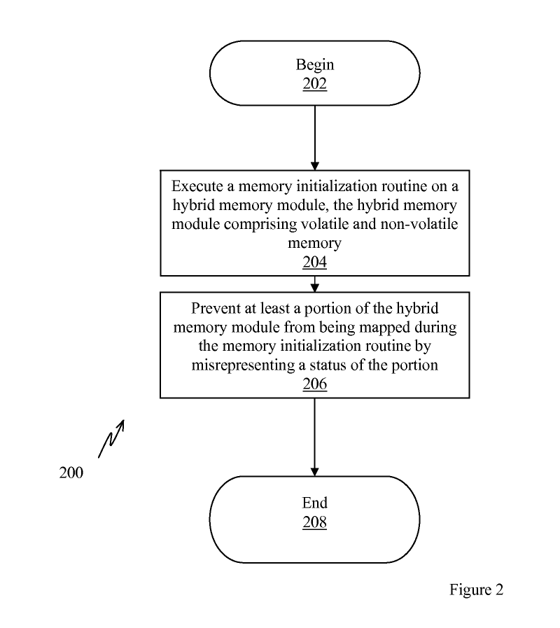

FIG. 2 illustrates a method 200 of preventing at least a portion of a hybrid memory module 104 from being mapped 112 beginning at 202 and ending at 208. The method 200 may comprise any step described above. At 204, a memory controller 110 may execute a memory initialization routine on the hybrid memory module 104. In at least one example, the memory initialization routine may comprise a memory interleaving algorithm to assign available non-contiguous memory to store contiguous data. A step of such a routine may comprise receiving the status of memory available or unavailable for interleaving. At 206, a processor 102 may prevent at least a portion of the hybrid memory module 104, e.g. the non-volatile memory 108, a portion of the non-volatile memory 108, or the entire hybrid memory module 104, from being mapped 112 during the memory initialization routine by misrepresenting the status of the portion. For example, the portion of memory may be represented as unavailable though it is actually available. As such, the hybrid memory module 104 may be excluded from being available in the memory interleaving algorithm. For example, the processor 102 may send a set of physical addresses to the memory controller 110 with a status of available, the set excluding any physical address corresponding to the portion of memory. The memory controller 110 may be restricted to choosing only the received physical addresses for mapping. As another example, the processor 102 may send a set of physical addresses to the memory controller 110 with a status of unavailable, the set including physical addresses corresponding to the portion of memory. Alternatively, a starting and ending address may be sent to exclude the range of addresses between the starting and ending address.

Also, the portion of memory may be represented as defective though the portion of memory is not defective. For example, the processor 102 may send a set of physical addresses to the memory controller 110 with a status of defective, the set including physical addresses corresponding to the portion of memory. Alternatively, the starting and ending address may be sent to exclude the range of addresses between the starting and ending address. In another example, the processor 102 may send a slot number to memory controller 110 with a status of defective, the slot number corresponding to the slot occupied by the portion of memory. Conversely, only the identity and status of non-defective slots may be sent. The memory controller 110 may exclude all addresses or slots received with a status of defective from being mapped in memory map 112, or the memory controller 110 may include all addresses or slots received with a non-defective status in memory map 112.

In another example, the portion of memory may be represented as not installed though the portion of memory is installed. For example, the processor 102 may send a set of physical addresses to the memory controller 110 with a status of uninstalled, the set including physical addresses corresponding to the portion of memory. Alternatively, the starting and ending address may be sent to exclude the range of addresses between the starting and ending address. In another example, the processor 102 may send a slot number to memory controller 110 with a status of uninstalled, the slot number corresponding to the slot in which the portion of memory is installed. Conversely, only the identity and status of slots with memory installed may be sent. The memory controller 110 may exclude all addresses or slots received with a status of uninstalled from being mapped in memory map 112, or the memory controller 110 may include all address or slots received with an installed status in memory map 112.

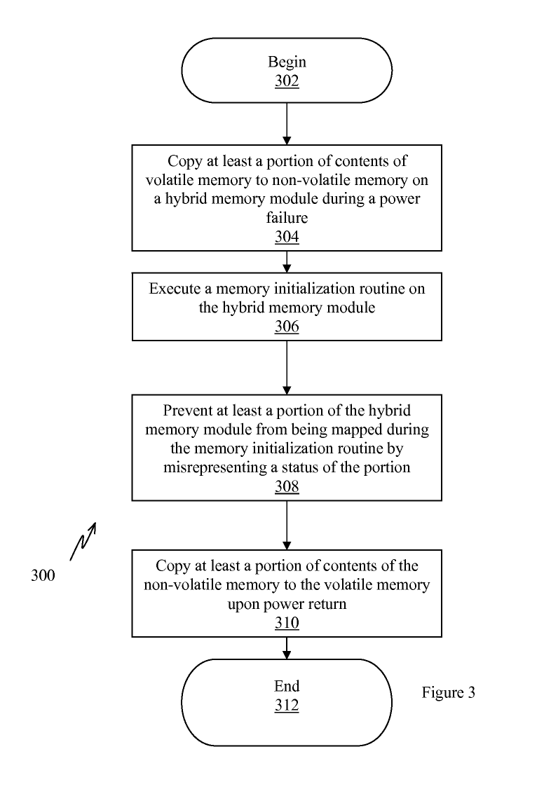

FIG. 3 illustrates a method 300 of preventing at least a portion of a hybrid memory module from being mapped beginning at 302 and ending at 312. The method 300 may comprise any step described above. At 304, a memory controller 110 copies at least a portion of contents of volatile memory 106 to non-volatile memory 108 on a hybrid memory module 104 during a power failure or imminent power failure.

At 306, a memory controller 110 may execute a memory initialization routine on the hybrid memory module 104. In at least one example, the memory initialization routine may comprise a memory interleaving algorithm to assign available non-contiguous memory to store contiguous data. A step of such a routine may comprise receiving the status of memory available or unavailable for interleaving. At 308, a processor 102 may prevent at least a portion of the hybrid memory module 104, e.g. the non-volatile memory 108, a portion on the non-volatile memory 108, or the entire hybrid memory module 104, from being mapped 112 during the memory initialization routine by misrepresenting the status of the portion. For example, the portion of memory may be represented as unavailable though it is actually available. As such, the hybrid memory module 104 may be excluded from being available in a memory interleaving algorithm. For example, the processor 102 may send a set of physical addresses to the memory controller 110 with a status of available, the set excluding any physical address corresponding to the portion of memory. The memory controller 110 may be restricted to choosing only the received physical addresses for mapping. As another example, the processor 102 may send a set of physical addresses to the memory controller 110 with a status of unavailable, the set including physical addresses corresponding to the portion of memory. Alternatively, a starting and ending address may be sent to exclude the range of addresses between the starting and ending address.

Also, the portion of memory may be represented as defective though the portion of memory is not defective. For example, the processor 102 may send a set of physical addresses to the memory controller 110 with a status of defective, the set including physical addresses corresponding to the portion of memory. Alternatively, the starting and ending address may be sent to exclude the range of addresses between the starting and ending address. In another example, the processor 102 may send a slot number to memory controller 110 with a status of defective, the slot number corresponding to the slot occupied by the portion of memory. Conversely, only the identity and status of non-defective slots may be sent. The memory controller 110 may exclude all addresses or slots received with a status of defective from being mapped in memory map 112, or the memory controller 110 may include all addresses or slots received with a non-defective status in memory map 112.

In another example, the portion of memory may be represented as not installed though the portion of memory is installed. For example, the processor 102 may send a set of physical addresses to the memory controller 110 with a status of uninstalled, the set including physical addresses corresponding to the portion of memory. Alternatively, the starting and ending address may be sent to exclude the range of addresses between the starting and ending address. In another example, the processor 102 may send a slot number to memory controller 110 with a status of uninstalled, the slot number corresponding to the slot in which the portion of memory is installed. Conversely, only the identity and status of slots with memory installed may be sent. The memory controller 110 may exclude all addresses or slots received with a status of uninstalled from being mapped in memory map 112, or the memory controller 110 may include all address or slots received with an installed status in memory map 112.

At 310, at least a portion of contents of the non-volatile memory are copied to the volatile memory upon power return.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a hybrid memory module comprising volatile memory and non-volatile memory; and
a processor coupled to the hybrid memory module, the processor to prevent the hybrid memory module from being mapped during a memory initialization routine by misrepresenting a status of the hybrid memory module.

2. The system of claim 1, wherein the processor represents that the hybrid memory module is defective though the hybrid memory module is not defective.

3. The system of claim 1, wherein the processor represents that the hybrid memory module is not installed though the hybrid memory module is installed.

4. The system of claim 1, wherein at least a portion of contents of the volatile memory are copied to the non-volatile memory during power failure.

5. The system of claim 4, wherein at least a portion of contents of the non-volatile memory are copied to the volatile memory upon power return.

6. The system of claim 1, wherein the hybrid memory module is not included as available memory in a memory interleaving algorithm during initialization following a power failure.

7. A method, comprising:
executing a memory initialization routine on a hybrid memory module, the hybrid memory module comprising volatile memory and non-volatile memory; and
preventing at least a portion of the hybrid memory module from being mapped during the memory initialization routine by misrepresenting a status of the portion.

8. The method of claim 7, further comprising copying at least a portion of contents of the volatile memory to the non-volatile memory during a power failure.

9. The method of claim 8, further comprising copying at least a portion of contents of the non-volatile memory to the volatile memory upon power return.

10. The method of claim 7, further comprising excluding the portion from being available memory in a memory interleaving algorithm.

11. A system, comprising:
a processor;
a hybrid memory module coupled to the processor, comprising:
volatile memory; and
non-volatile memory; and
a memory controller coupled to the hybrid memory module;
wherein the processor prevents at least a portion of the hybrid memory module from being mapped by the memory controller during a memory initialization routine by misrepresenting a status of the portion.

12. The system of claim 11, wherein the memory controller does not detect that the portion is installed though the hybrid memory module is installed.

13. The system of claim 11, wherein at least a portion of contents of the volatile memory are copied to the non-volatile memory during a power failure.

14. The system of claim 13, wherein at least a portion of contents of the non-volatile memory are copied to the volatile memory upon power return.

15. The system of claim 11, wherein the memory controller does not include the portion as available memory in a memory interleaving algorithm following power return.
